(19) United States
(12) Patent Application Publication
(10) Pub. No.: US 2013/0275745 A1
(43) Pub. Date: Oct. 17, 2013

(54) System and Method for Secure Communication

(71) Applicant: NCP ENGINEERING GMBH, Numberg (DE)

(72) Inventor: Jochen Gundelfinger, Grafenberg (DE)

(21) Appl. No.: 13/862,269

(22) Filed: Apr. 12, 2013

(30) Foreign Application Priority Data
Apr. 13, 2012 (DE) 102012007430.1

(51) Int. Cl. H04L 29/06; G06F 21/31

(52) U.S. Cl. CPC H04L 63/0471; G06F 21/31
USPC 713/153

(57) ABSTRACT

The invention specifies a method and a system for secure communication of a first computing device and a network. A second computing device with a hardened operating system is employed. The second computing device is different from the operating system of the first computing device. An authentication module in the second computing device authenticates a user. An encryption module in the second computing device encrypts the data received from the first computing device, so that an encrypted communication with the network is made possible. A decryption module in the second computing device decrypts the encrypted data received from the network for the first computing device.

### RELATED APPLICATION

This patent application claims priority under 35 U.S.C. §119 to German Patent Application No. 102012007430.1, filed Apr. 13, 2012. The entire contents of the above-identified priority application are hereby fully incorporated herein by reference.

### TECHNICAL FIELD

The present invention concerns a system and a method for secure communication.

### BACKGROUND

Modern communication systems, such as for telecommunications and/or data transmission, have only a slight security and can be relatively easily—depending on technical skills—eavesdropped upon or manipulated. In this way, intruders can gain access to sensitive data and information or even to the corresponding computer systems themselves and download malware, for example, on the affected computer equipment. The securing of a link with a network, such as a company's network or the Internet, is especially important—for example, to prevent unauthorized access to the company's network or unauthorized access to a computer from the Internet.

One problem with traditional systems and methods for communication is that these systems or methods do not enable a secure communication. For example, available protection mechanisms can often be easily disabled and/or circumvented, or the systems are difficult to configure or unwieldy to use. It is therefore one problem of the present invention to provide a system and a method for communication that enables a secure communication. This problem is solved by the system and method described herein.

### SUMMARY

In certain example aspects described herein, a method for providing secure communications comprises a first computing device connected to and in communication with a second computing device. The second computing device authenticates a user. In response to authenticating the user, the second computing device generates a user authentication command based on the user authentication. The second computing device receives data from the first computing device and encrypts the data based at least in part on the generated user authentication command. The second computing device transmits the encrypted data via a network and receives an encrypted second data via the network. The second computing device decrypts the encrypted second data based at least in part on the user authentication command and transmits the decrypted second data to the first computing device.

In another example embodiment described herein, a computer program product comprises a non-transitory computer-readable medium having computer-readable program instructions embodied thereon that when executed by a computer cause the computer to provide secure communications. The non-transitory computer-readable medium comprises computer-readable program instructions to authenticate a user. In response to authenticating the user, a user authentication command is generated based on the user authentication. The non-transitory computer-readable medium comprises computer-readable program instructions to receive data from a first computing device and encrypt the data based at least in part on the generated user authentication command. The encrypted data is transmitted via a network. The non-transitory computer-readable medium comprises computer-readable program instructions to receive an encrypted second data via the network, decrypt the encrypted second data based at least in part on the user authentication command, and transmit the decrypted second data to the first computing device.

These and other aspects, objects, features, and advantages of the example embodiments will become apparent to those having ordinary skill in the art upon consideration of the following detailed description of illustrated example embodiments.

### BRIEF DESCRIPTION OF THE DRAWINGS

FIG. 1 is a block diagram depicting a secure communication system, in accordance with certain example embodiments.

FIG. 2 is a block flow diagram depicting a method for providing secure communications, in accordance with certain example embodiments.

FIG. 3 is a block diagram depicting a computer machine and module, in accordance with certain example embodiments.

### DETAILED DESCRIPTION OF THE EXAMPLE EMBODIMENTS

### Overview

The example embodiments described herein provide computer-implemented techniques for providing secure communications. In certain example embodiments, the second computing device is connected to a network and can communicate with it. In particular, a secure communication between the first computing device and the network is made possible via the second computing device.

The communication can take place in any desired manner, and in particular it can involve the transmission of speech, data, or the like. Thus, the system enables a secure telecommunications and/or a secure data transmission.

In an example embodiment, the link between the second computing device and the network enables an encrypted data transmission, in which the data being transmitted is encrypted, say, with an encryption code.

In an example embodiment, the second computing device is a mobile computer device, such as a smartphone, a tablet computer, a laptop, or a mobile modem. The first computing device can be any desired computing device, such as a laptop, an ordinary desktop computer, or a tablet computer.

In an example embodiment, the first computing device comprises a first operating system, and the second computing device comprises a second operating system. According to an exemplary embodiment of the invention, the second operating system is a hardened operating system. In an example embodiment, the first operating system and the second operating system differ from each other, in other words, they are not identical. The second operating system advantageously provides a higher security than the first operating system because of one or more protection mechanisms.

In an example embodiment, the second computing device comprises an authentication module for authenticating a user. In particular, the authentication module can be designed to authenticate the user of the first and/or the second computing device. The authentication module generates, based on the user authentication, one or more commands for an encryption module and/or a decryption module.

The second computing device according to the invention comprises a receiving module for receiving of data from the first computing device, an encryption module for encrypting the data received from the first computing device based on the command or commands generated by the authentication module, a transmitting module for transmitting the data encrypted by the encryption module to the network, a receiving module for receiving encrypted data from the network, a decryption module for decrypting the encrypted data received from the network based on the command or commands of the authentication module, and a transmitting module for transmitting the decrypted data to the first computing device.

In another example embodiment, the communication between the first computing device and the second computing device can also be encrypted. In this case, additional encryption and decryption module can be present in the first computing device and in the second computing device.

In an example embodiment, the link between the transmitting module and the network, as well as the link between the receiving module and the network, each time involves a wireline link. In another example embodiment, the link between the transmitting module and the network, as well as the link between the receiving module and the network, each time involves a wireless link, for example, a WLAN link or a mobile radio link.

In an example embodiment, the link between the receiving module and the first computing device as well as the link between the transmitting module and the first computing device is a wireline link. Alternatively, however, a wireless link can also be used, such as a Bluetooth link, a WLAN link or a mobile radio link.

In an example embodiment, the link between the transmitting module and the network as well as the line between the receiving module and the network is a wireline link, whereas the link between the receiving module and the first computing device as well as that between the receiving module and the first computing device is a wireless link.

In another example embodiment, the link between the transmitting module and the network as well as the link between the receiving module and the network is a wireless link, whereas the link between the receiving module and the first computing device as well as that between the receiving module and the first computing device is a wireline link. However, embodiments with exclusively wireless or exclusively wireline links are also possible. This allows selecting the optimal link method each time for each section of the link.

In an example embodiment, the encryption module is a certified encryption module, and the decryption module are a certified decryption module.

A further embodiment constitutes a method for secure communication, with the steps: connecting a first computing device, which comprises a first operating system, to a second computing device, wherein the second computing device is a mobile computing device and comprises a second operating system, wherein the second operating system is a hardened operating system, authentication of a user and generating of a command based on the user authentication, receiving of data from the first computing device, encryption of the data received from the first computing device based on the user authentication command, transmitting of the encrypted data to a network, receiving of encrypted data from the network, decryption of the data received from the network based on the user authentication command, and transmitting of the decrypted data to the first computing device.

In an example embodiment, the link between the transmitting module and the network and the link between the network and the receiving module is a point-to-point link.

In another example embodiment, the link between the receiving module and the first computing device as well as that between the transmitting module and the first computing device is a multipoint link.

The inventive functionality of the invention will be explained in more detail in the following description, read in conjunction with the figures illustrating the program flow.

### Example System Architectures

Turning now to the drawings, in which like numerals indicate like (but not necessarily identical) elements throughout the figures, example embodiments are described in detail.

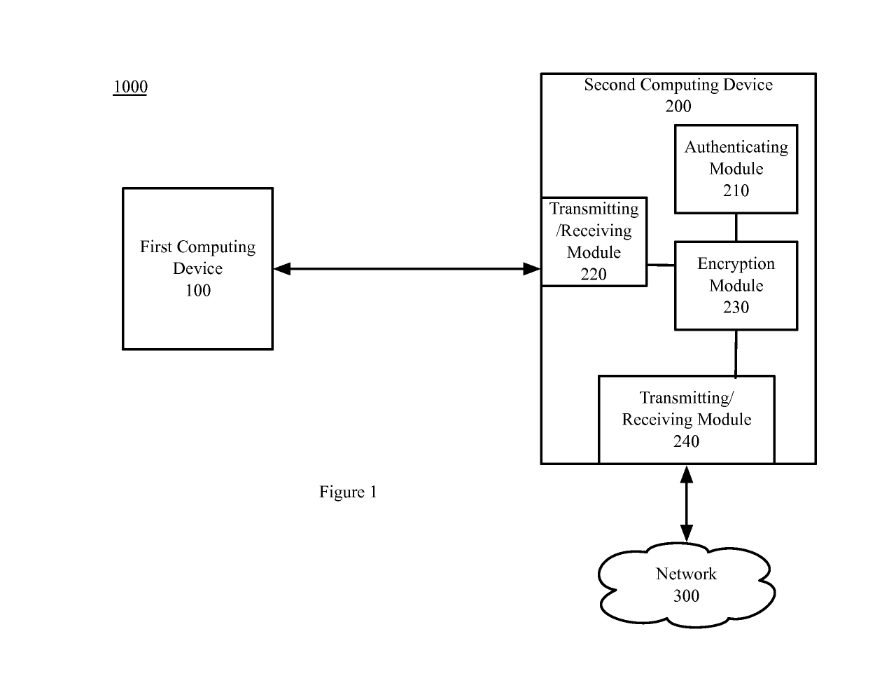

FIG. 1 is a block diagram depicting a secure communication system 1000, in accordance with certain example embodiments. As depicted in FIG. 1, the example secure communication system 1000 comprises a first computing device 100 and a second computing device 200 linked to a network 300.

The first computing device 100 can be an ordinary computer, a desktop computer, a laptop or a tablet computer, or the like.

The first computing device 100 has a first operating system. The first operating system is preferably a Windows operating system, such as Windows XP, Windows Vista, Windows 7, Windows 8, a Macintosh operating system, such as Mac OS X, a Linux or UNIX derivate, or any other desktop operating system. If the first computing device is also a mobile computing device, such as a tablet computer or a smartphone, the operating system can also be a corresponding tablet or smartphone operating system, such as Google Android, iOS, Windows, a Linux or UNIX derivate, or any other system.

The second computing device 200 is preferably a mobile computing device and especially preferably it is a telephone (such as a mobile telephone or a smartphone), a modem, a set-top box or the like. The second computing device 200 has a second operating system, such as a smartphone operating system like Windows, iOS, Google Android, or a Linux or UNIX derivate.

In particular, the second operating system is a hardened operating system. A hardened operating system is an operating system for which one or more precautions have been taken to improve the security of the operating system. This precaution should make attacks and/or access of unauthorized persons to the system more difficult.

An operating system can be hardened, for example, by omitting, removing, or deactivating various services or functions that are not absolutely necessary. For example, services like webserver service, a file server service, an update service, etc., can be omitted, removed, or deactivated in order to harden the operating system.

Another option for hardening the second operating system is to use a firewall and/or the closing of unneeded ports. Further options for hardening an operating system are the use of routines verified on source code level and/or the use of security-certified libraries, and these measures can be adopted by themselves or also in combination. The hardened operating system can be, for example, Windows, Linux (e.g., Android), Unix, iOS, or any other hardened operating system. Advantageously, the hardened operating system differs by one or more measures from the standard versions of these operating systems.

In an example embodiment, the first and the second operating system are not identical, but rather differ from each other. The use of identical or largely similar cores, such as those of the smartphones and desktop versions of Windows 8 or those of the different Linux and Unix derivatives for mobile or desktop computers, does not rule out these being different operating systems in the sense of the present invention.

In an example embodiment, the second computing device is a smartphone with a hardened Android operating system, and the first computing device is a laptop or a notebook with a Windows operating system.

The second computing device 200 furthermore has a receiving module 220 for the receiving of data from the first computing device 100, a transmitting module 240 for the transmitting of data to the network 300, a receiving module 240 for the receiving of data from the network 300, and a transmitting module 220 for the transmitting of data to the first computing device 100. Different transmission techniques can be used for the transmitting and receiving of the particular data.

In another example embodiment, the transmitting/receiving modules (modules 220 and 240) can constitute separate components.

For the link between the first computing device 100 and the transmitting module 220, as well as that between the first computing device 100 and the transmitting module 220, one can use wireline or also wireless links, for example. Wireless links are suited especially when the first computing device is also a mobile device, such as a mobile computer, a laptop or a tablet computer. The wireless link can be, for example, a WLAN link or a Bluetooth link.

The link between the receiving module 220 and the first computing device 100, as well as that between the transmitting module 220 and the first computing device 100, can be especially configured for transmission of unencrypted data. This makes it possible to do without encryption module in the first computing device 100.

The link between the transmitting module 240 and the network 300, as well as that between the network 300 and the receiving module 240, can be configured to transmit or receive encrypted data. This enables an encrypted and thus eavesdropping-secure communication between the second computing device 200 and the network 300, such as the Internet.

The second computing device 200 moreover comprises an authentication module 210 for the authentication of a user. In an example embodiment, the user of the second computing device can be identified and authenticated in this way.

The authentication module 210 can identify the user, for example, by an identification card inserted into a reading module (not shown) of the second computing device 200, such as a smartcard or an electronic identity document, and authenticate the user for example by comparing with an internal or external database, in other words, determine that the user is authorized to use the system.

Other options for authentication of a user are, for example, entering a user-defined code (such as a PIN), detecting of a biometric feature (such as a fingerprint), and other measures at the second computing device 200 that are known to the skilled person. For example, the user can enter a PIN on a smartphone serving as the second computing device 200 for the authentication.

The authentication module 210 can additionally or alternatively be designed to enable the authentication of a user of the first computing device 100. For example, a user of the first computing device 100 can be identified by an identification card inserted into the first computing device 100 or by entering a user-defined code at the first computing device 100, such as a PIN, and be authorized to use the system. For this, data used for the authentication of the user is transmitted via the link between the first computing device 100 and the second computing device 200 to the second computing device 200, preferably by an encrypted link.

Upon successful authentication of a user, the authentication module 210 generates one or more commands.

The second computing device 200, moreover, has a module 230 for encryption of data and for decryption of data. In an example embodiment, a permanently predefined encryption or decryption code can be used, for example, or also a user-dependent variable or user-dependent predefined code.

In an example embodiment, the encryption and decryption occurs in consideration and/or use of one or more commands issued by the authentication module 210. For example, after the user authentication by the authentication module 210, the authentication module 210 can issue a command to the encryption and/or decryption module 230, whereupon the encryption module 230 generates a user-defined encryption and/or decryption code. This code can then be used to allow the user access to encrypted data saved in the network 300 or received via the network 300. In another example embodiment, the command can also be a direct code for the encryption and/or decryption. For example, such a code can be saved on a smartcard used for the authentication.

In an example embodiment, the encryption module 230 is a certified encryption module, and the decryption module 230 is a certified decryption module. The receiving module 220 of the second computing device 200 is designed to receive unencrypted data from the first computing device 100 and relay it to the encryption module 230.

The encryption module 230 encrypts this data based on the command(s) of the authentication module 210 and relays the encrypted data to the transmitting module 240. The transmitting module 240 is designed to transmit the encrypted data provided by the encryption module 230 to the network 300, such as the Internet, via an encrypted communication link.

The receiving module 240 is designed to receive encrypted data via an encrypted link to the network 300, such as the Internet, and relay it to the decryption module 230. The decryption module 230 is designed to decrypt the encrypted data provided by the receiving module 240 and relay this decrypted data to the transmitting module 220. The transmitting module 220, in turn, is designed to transmit the decrypted data provided by the decryption module 230 to the first computing device 100 via a wireless or wireline link.

The encrypted link between the transmitting module 240 and the network 300, as well as the encrypted link between the network 300 and the receiving module 240, can be realized by module of the most diverse communication module. In particular, wireline communication links such as ISDN or DSL, VDSL, or any other wireline communication module are possible. But, the communication can also be realized, in particular, via a wireless communication link, such as a WLAN link or a mobile radio link. The most diverse technologies can be used for this action, including GSM, GPRS, EDGE, UMTS, HSDPA, HSUPA, HSPA, HSPA+, LTE, LTE Advanced, WIMAX, etc.

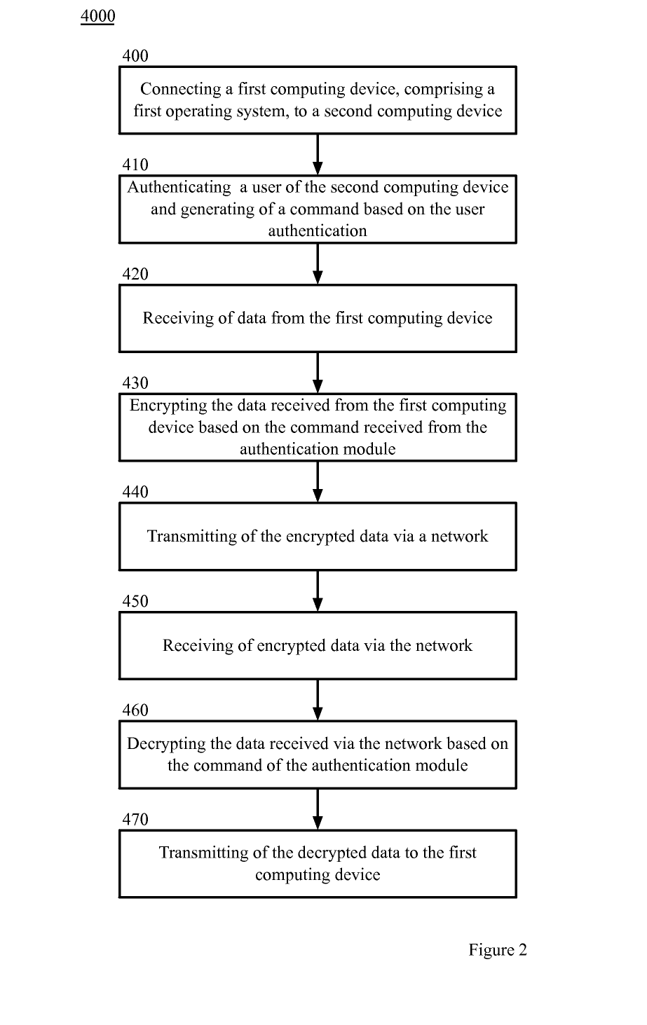

The components of the example operating environment 1000 are described hereinafter with reference to the example methods illustrated in FIG. 2. The example methods of FIG. 2 may also be performed with other systems and in other environments.

### Example System Processes

FIG. 2 is a block flow diagram depicting a method 4000 for providing secure communications, in accordance with certain example embodiments. The method 4000 is described with reference to the components illustrated in FIG. 1.

The method 4000 comprises in a first step 400 the connecting of a first computing device, comprising a first operating system, to a second computing device. The first computing device can be, for example, a first computing device 100 per the above, and the second computing device can be the second computing device 200.

In a second step 410 of the method 4000, a user of the first or second computing device is authenticated, for example, in an authentication module 210 of the second computing device, and a command is generated based on the user authentication.

In a step 420, data is received from the first computing device, for example, by a receiving module 220 of the second computing device 200.

In a step 430, the data received from the first computing device is completely or at least partly encrypted based on the command generated during the authentication.

In a step 440, the data, completely or partially encrypted, is transmitted to the network, for example from a transmitting module 240 of the second computing device 200. The network can be, for example, the network 300, for example, a company network or the Internet.

In a step 450, encrypted data is received from the network, for example, in response to data transmitted to the network.

In a step 460, the encrypted data received from the network is decrypted, for example, in the decryption module 230, and this action can be based on the command of the user authentication.

In a step 470, the decrypted data is then transmitted to the first computing device 100.

This method 4000 enables a secure communication between a first computing device and a network and/or network device.

### Other Example Embodiments

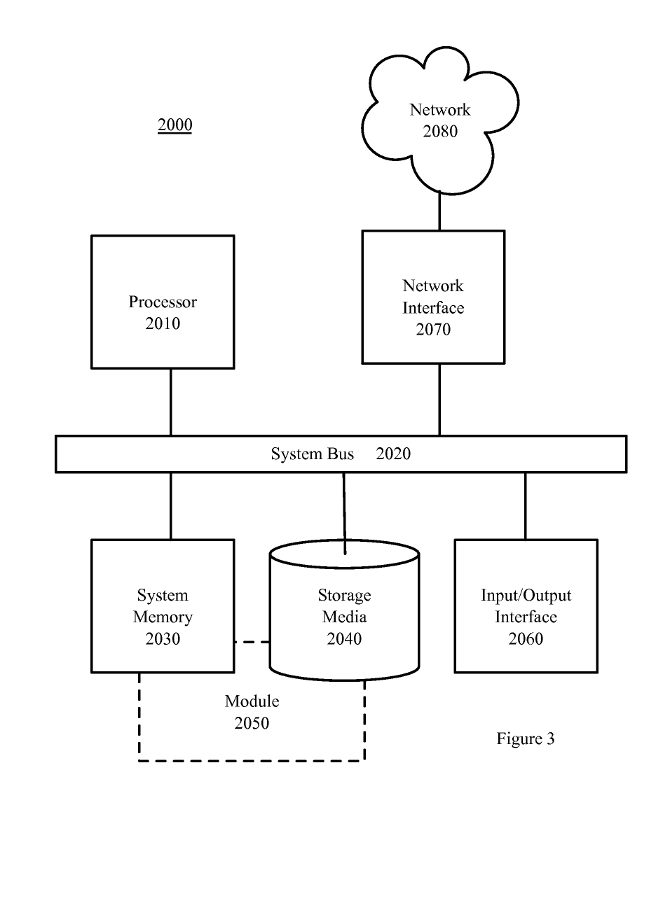

FIG. 3 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a Smartphone, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 may also include volatile memories such as random access memory (“RAM”), static random access memory (“SRAM”), dynamic random access memory (“DRAM”), and synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, biometric readers, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (“SOC”), system on package (“SOP”), or ASIC device.

In situations in which the systems discussed here collect personal information about users, or may make use of personal information, the users may be provided with a opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described herein. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the invention claimed herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

What is claimed is:

1. A computer-implemented method for providing secure communications, comprising:
authenticating, by a second computing device, a user, wherein the second computing device is connected to and separate from a first computing device, and wherein the second computing device comprises a hardened operating system;
in response to authenticating the user, generating, by the second computing device, a user authentication command based on the user authentication;
receiving, by the second computing device, data from the first computing device;
encrypting, by the second computing device, the data received from the first computing device based at least in part on the generated user authentication command;
transmitting, by the second computing device and via a network, the encrypted data;
receiving, by the second computing device and via the network, an encrypted second data;
decrypting, by the second computing device, the encrypted second data based at least in part on the user authentication command; and
transmitting, by the second computing device, the decrypted second data to the first computing device.

2. The method of claim 1, further comprising connecting the first computing device to the second computing device.

3. The method of claim 1, wherein the second computing device is a mobile computing device.

4. The method of claim 1, wherein transmitting the encrypted data via the network comprises a wireline transmission, and wherein receiving the encrypted second data via the network comprises a wireline reception.

5. The method of claim 1, wherein transmitting the encrypted data via the network is performed via a wireless transmission, and wherein receiving the encrypted second data via the network is performed via a wireless reception.

6. The method of claim 5, wherein transmitting the encrypted data via the network comprises a Bluetooth or a WLAN transmission, and wherein receiving the encrypted second data via the network comprises a Bluetooth or a WLAN reception.

7. The method of claim 1, wherein the encrypting comprises a security-certified encryption, and the decrypting comprises a security-certified decryption.

8. The method of claim 1, wherein receiving the data from the first computing device is performed via a wireline reception, and wherein transmitting the decrypted second data to the first computing device is performed via a wireline transmission.

9. The method of claim 1, wherein receiving the data from the first computing device is performed via a wireless reception, and wherein transmitting the decrypted second data to the first computing device is performed via a wireless transmission.

10. The method of claim 9, wherein transmitting the decrypted second data to the first computing device comprises a Bluetooth or WLAN transmission, and wherein receiving the data from the first computing device comprises a Bluetooth or a WLAN reception.

11. A system for providing secure communications, comprising:
a first computing device, the first computing device comprising:
a first storage device, and
a first processor configured to execute computer-executable instructions stored in the first storage device to cause the system to:
link the first computing device to a second computing device,
transmit first data to the second computing device, and
receive decrypted second data from the second computing device; and
a second computing device, the second computing device comprising:
a second storage device, and
a second processor configured to execute computer-executable instructions stored in the second storage device to cause the system to:
authenticate a user,
generate a user authentication command in response to authenticating the user,
receive the first data from the first computing device,
encrypt the first data received from the first computing device based at least in part on the user authentication command,
transmit the encrypted first data via a network,
receive encrypted second data via the network,
decrypt the encrypted second data received via the network, based on the user authentication command, and
transmit the decrypted second data to the first computing device.

12. The system of claim 11, wherein transmitting the encrypted data via the network comprises a wireline transmission and wherein receiving the encrypted second data via the network comprises a wireline reception.

13. The system of claim 11, wherein transmitting the encrypted data via the network performed via a wireless transmission and wherein receiving the encrypted second data via the network performed via a wireless reception.

14. The system of claim 13, wherein transmitting the encrypted data via the network comprises a Bluetooth or a WLAN transmission and wherein receiving the encrypted second data via the network comprises a Bluetooth or a WLAN reception.

15. The system of claim 11, wherein the encrypting comprises a security-certified encryption, and the decrypting comprises a security-certified decryption.

16. The system of claim 11, wherein receiving the data from the first computing device is performed via a wireline reception, and wherein transmitting the decrypted second data to the first computing device is performed via a wireline transmission

17. The system of claim 11, wherein receiving the data from the first computing device is performed via a wireless reception, and wherein transmitting the decrypted second data to the first computing device is performed via a wireless transmission

18. The system of claim 17, wherein transmitting the decrypted second data to the first computing device comprises a Bluetooth or WLAN transmission and wherein receiving the data from the first computing device comprises a Bluetooth or a WLAN reception.
